(19) United States
(12) Patent Application Publication
(10) Pub. No.: US 2011/0292361 A1
(43) Pub. Date: Dec. 1, 2011

(54) Exposure apparatus

(75) Inventors: Koji Watanabe, Itabashi-ku (JP); Yukio Ishiba, Itabashi-ku (JP); Kenichi Nakano, Itabashi-ku (JP)

(73) Assignee: Kabushiki Kaisha TOPCON, Tokyo (JP)

(21) Appl. No.: 13/068,982

(22) Filed: May 25, 2011

(30) Foreign Application Priority Data
May 31, 2010 (JP) 2010-123750

(51) Int. Cl. G03B 27/68

(52) U.S. Cl. 355/52

(57) ABSTRACT

An exposure apparatus including a warp deformation forming mechanism having a plane-parallel plate for warp deformation provided on a projection optical path of a mask pattern to be projected to a work substrate, and configured to be deformed by warping, a restraint member configured to cause an intermediate part of the plane-parallel plate between neighboring two of corner parts to serve as a fulcrum, each corner part formed by two intersecting sides of the plane-parallel plate, and a pressure member configured to warp and deform the plane-parallel plate with the restraint member used as a fulcrum by applying a pressurizing force to the corner parts of the plane-parallel plate in an optical axis direction of the projection optical path.

### PRIORITY CLAIM

The present application is based on and claims priority from Japanese Patent Application No. 2010-123750, filed on May 31, 2010, the disclosure of which is hereby incorporated by reference in its entirety.

### BACKGROUND

1. Technical Field

The present invention relates to an exposure apparatus capable of projecting a mask pattern image corresponding to deformation which occurs in a work substrate.

2. Description of the Related Arts

One of conventionally-known exposure apparatuses is configured to project a mask pattern image corresponding to the expansion and contraction of a work substrate by: measuring the temperature of the work substrate; and changing the magnifications of the mask pattern image in a left-to-right direction (X direction) and a front-to-back direction (Y direction) according to the temperature of the work substrate with use of two plane-parallel plates arranged on a projection optical path. For this purpose, one of two plane-parallel plates is curved in the left-to-right direction (X direction) by being bent in a thickness direction thereof with paired front-to-back sides thereof used as fulcrums and the other plane-parallel plate is curved in the front-to-back direction (Y direction) by being bent in a thickness direction thereof with paired left-to-right sides thereof used as fulcrums (see Japanese Patent Application Publication No. Hei 10-303115, for example).

Further, an exposure apparatus having such a configuration that the two plane-parallel plates are rotatable is also known (see Japanese Patent Application Publication No. 2003-223003, for example).

Furthermore, an exposure apparatus is known which is configured to project a mask image, which corresponds to the expansion and contraction of a work substrate, to the work substrate without changing the curvatures of the two respective plane-parallel plates (see Japanese Patent Application Publication No. 2006-292902, for example).

There are various work substrates such as a printed circuit board, a TAB tape, and a multilayer printed circuit board. For example, a printed circuit board changes its aspect ratio due to tension caused by the difference in thermal expansion between epoxy resin and copper foil; and likewise, a TAB tape changes its aspect ratio due to the difference in thermal expansion between polyimide resin and copper foil.

In the case of a multilayer printed circuit board, for example, a lower pattern previously formed is already expanded or contracted due to the expansion or contraction of the work substrate when an upper pattern is newly formed on the lower pattern.

These conventional exposure apparatuses described above are capable of correcting the aspect ratio of the mask image corresponding to the expansion or contraction of the work substrate.

Meanwhile, the demand for formation of fine exposure patterns on work substrates has been increasing recently. On the other hand, due to the difference in thermal expansion or other reasons, work substrates are deformed by expansion or contraction not only in the front-to-back and/or left-to-right directions, but also in diagonal directions or any other directions. For example, work substrates are distorted and deformed into various shapes such as a trapezoid shape and a rhombus shape.

Since the conventional exposure apparatuses are designed to make magnification correction, the conventional exposure apparatuses have a problem of having difficulty projecting a mask pattern image corresponding, to an ultimate extent, to distortion/deformation of a work substrate onto the work substrate.

### SUMMARY

The present invention has been made in view of the above circumstances. An object of the present invention is to provide an exposure apparatus capable of projecting a mask pattern image made to correspond, to an ultimate extent, to the deformation of a work substrate.

One embodiment of the present invention provides an exposure apparatus comprising a warp deformation forming mechanism including: a plane-parallel plate for warp deformation provided on a projection optical path of a mask pattern to be projected to a work substrate, and configured to be deformed by warping; a restraint member configured to cause an intermediate part of the plane-parallel plate between neighboring two of corner parts to serve as a fulcrum, each corner part formed by two intersecting sides of the plane-parallel plate; and a pressure member configured to warp and deform the plane-parallel plate with the restraint member used as a fulcrum by applying a pressurizing force to the corner parts of the plane-parallel plate in an optical axis direction of the projection optical path.

### BRIEF DESCRIPTION OF DRAWINGS

FIG. 1 is a view schematically illustrating an optical system of an exposure apparatus of an embodiment of the present invention.

FIG. 2 is a plan view showing a detailed configuration of a magnification correction mechanism shown in FIG. 1.

FIG. 3 is a side view showing the detailed configuration of the magnification correction mechanism shown in FIG. 2.

FIG. 4 is a plan view showing a detailed configuration of a left-to-right-direction magnification correcting mechanism shown in FIG. 2.

FIG. 5 is a side view showing the detailed configuration of the left-to-right-direction magnification correcting mechanism shown in FIG. 4.

FIG. 6 is a perspective view showing the detailed configuration of the left-to-right-direction magnification correcting mechanism shown in FIGS. 4 and 5.

FIG. 7 is a plan view showing a detailed configuration of a warp deformation forming mechanism shown in FIG. 2.

FIG. 8 is a side view showing a restraining state of restraint members shown in FIG. 7.

FIG. 9 is a side view showing a pressure-nipping state of pressure-nipping members shown in FIG. 7.

FIGS. 10A and 10B are schematic diagrams for explaining how the left-to-right-direction magnification correcting mechanism shown in FIG. 2 works. FIG. 10A is a schematic diagram showing how a first plane-parallel plate is supported. FIG. 10B is a schematic diagram showing, as seen from one side, how the first plane-parallel plate shown in FIG. 10A is curved.

FIGS. 11A to 11C are schematic diagrams for explaining how the warp deformation forming mechanism works. FIG. 11A is a schematic diagram showing, as seen in a planar direction, a state where: pressurizing forces in the same direction are respectively applied to paired vertices in a given diagonal direction of a third plane-parallel plate; and pressurizing forces in a direction opposite to the direction of the pressurizing forces applied to the paired vertices in the given diagonal direction are respectively applied to paired vertices in the other diagonal direction thereof. FIG. 11B is a schematic diagram showing, as seen from the side, the third plane-parallel plate to which the pressurizing forces are applied as shown in FIG. 11A. FIG. 11C is a schematic diagram emphatically showing a state where the third plane-parallel plate is deformed into a rhombus due to the pressurizing forces.

FIGS. 12A to 12C are schematic diagrams for explaining how the warp deformation forming mechanism works. FIG. 12A is a schematic diagram showing, as seen in a planar direction, a state where: pressurizing forces in the same direction are respectively applied to paired vertices on a given left-to-right side of the third plane-parallel plate; and pressurizing forces in a direction opposite to the direction of the pressurizing forces applied to the paired vertices on the given left-to-right side are respectively applied to paired vertices on the opposite side parallel to the given left-to-right side. FIG. 12B is a schematic diagram showing, as seen from the side, the third plane-parallel plate to which the pressurizing forces are applied as shown in FIG. 12A. FIG. 12C is a schematic diagram emphatically showing a state where the third plane-parallel plate is deformed into a vertical rhombus due to the pressurizing forces.

FIGS. 13A to 13C are schematic diagrams for explaining how the warp deformation forming mechanism works. FIG. 13A is a schematic diagram showing, as seen in a planar direction, a state where: pressurizing forces in the same direction are respectively applied to paired vertices on a given front-to-back side of the third plane-parallel plate; and pressurizing forces in a direction opposite to the direction of the pressurizing forces applied to the paired vertices on the given front-to-back side are respectively applied to paired vertices on the opposite side parallel to the given front-to-back side. FIG. 13B is a schematic diagram showing, as seen from the side, the third plane-parallel plate to which the pressurizing forces are applied as shown in FIG. 13A. FIG. 13C is a schematic diagram emphatically showing a state where the third plane-parallel plate is deformed into a horizontal rhombus due to the pressurizing forces.

### DESCRIPTION OF EMBODIMENT

### Embodiment

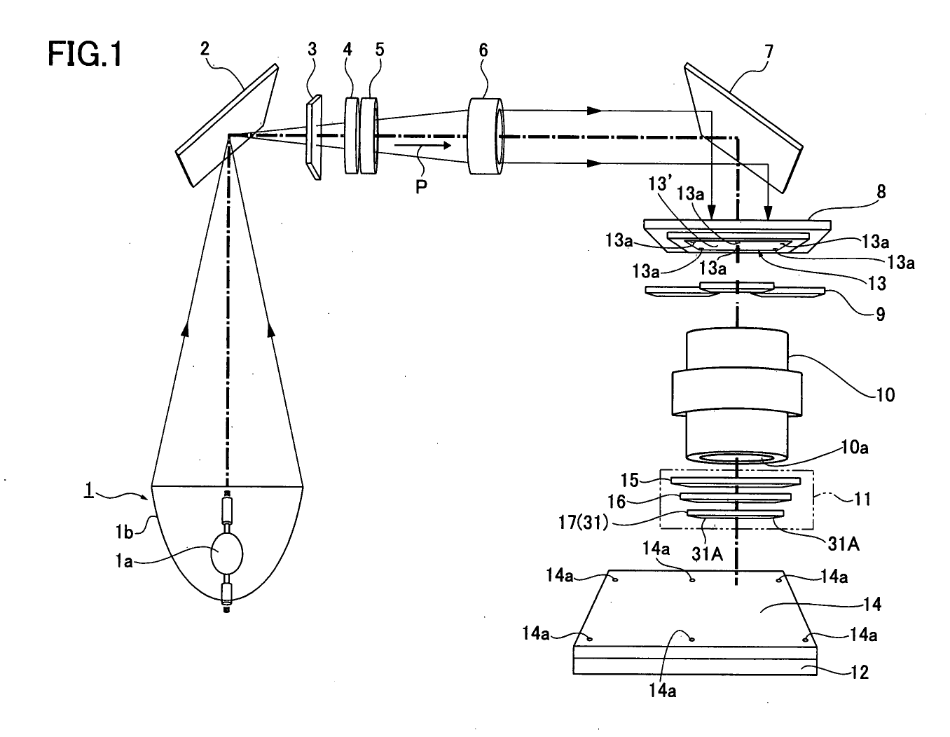

FIG. 1 is an explanatory diagram schematically illustrating an optical system of an exposure apparatus of the embodiment of the present invention. Reference numeral 1 denotes a light source part; 2 denotes a cold mirror; 3 denotes an exposure shutter; 4 denotes an ultraviolet (i-line) band-pass filter; 5 denotes an integrator lens; 6 denotes a collimator lens; 7 denotes a plane mirror; 8 denotes a mask stage; 9 denotes a mask blind; 10 denotes a projection lens holding cylinder; 11 denotes a magnification correction mechanism; and 12 denotes an exposure stage. Incidentally, the exposure shutter 3 is retracted from an optical path of the optical system as needed at the time of exposure.

The light source part 1 includes a mercury lamp 1a and a rotary ellipsoidal mirror 1b. The mercury lamp 1a is arranged at a first focal position of the rotary ellipsoidal mirror 1b. A light flux emitted from the mercury lamp 1a is reflected by the rotary ellipsoidal mirror 1b, and thus converged on a second focal position. The cold mirror 2 removes infrared rays of wavelengths longer than an infrared wavelength from the light flux, and reflects the resultant light flux in a range of wavelengths shorter than the wavelength of visible infrared light to guide it toward the band-pass filter 4. The band-pass filter 4 then cuts light beams of a wavelength range other than the wavelength range of an ultraviolet ray (i-line). As a light flux for exposure P, the resultant light flux is guided toward the integrator lens 5.

The integrator lens 5 makes the light-amount distribution of the light flux for exposure P substantially uniform, and guides the resultant light flux toward the collimator lens 6. The collimator lens 6 has its focal point at the second focal position, and forms the light flux for exposure P into a parallel light flux. The plane mirror 7 then bends the optical path of the resultant light flux, and guides it toward the mask stage 8.

The mask stage 8 is provided with a mask 13. A mask pattern 13′ to be formed on a work substrate 14 is formed in the mask 13. The mask 13 has alignment marks 13a used to align the mask 13 with the work substrate 14, which will be described later. The mask stage 8 is movable in a left-to-right (X) direction and a front-to-back (Y) direction by a drive mechanism, whose illustration is omitted.

The mask blind 9 is retracted from the projection optical path of the optical system as needed when the work substrate 14 is exposed to the light flux for exposure P.

A projection lens group 10a is provided in the projection lens holding cylinder 10. In this embodiment, the projection lens group 10a magnifies the pattern of the mask, 13 and forms an image of the resultant pattern on the work substrate 14.

The work substrate 14 is placed on the exposure stage 12. The work substrate 14 is square, for example, and has alignment marks 14a previously formed at appropriate positions. The exposure stage 12 is configured to be movable in the left-to-right (X) direction and the front-to-back (Y) direction by a drive mechanism, whose illustration is omitted.

Note that, although the alignment marks 13a, 14a in a size visible to the naked eye are emphatically shown in FIG. 1, they are actually in a size invisible to the naked eye.

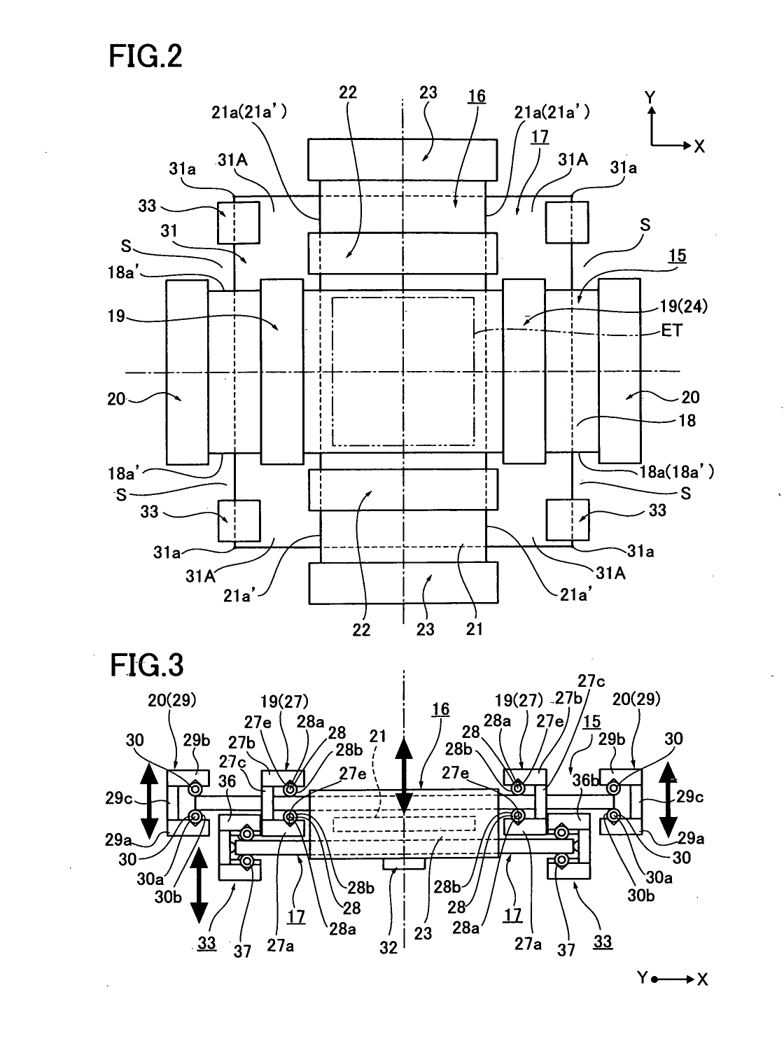

As shown in FIGS. 2, 3, the magnification correction mechanism 11 includes a left-to-right-direction magnification correcting mechanism 15, a front-to-back-direction magnification correcting mechanism 16, and a warp deformation forming mechanism 17.

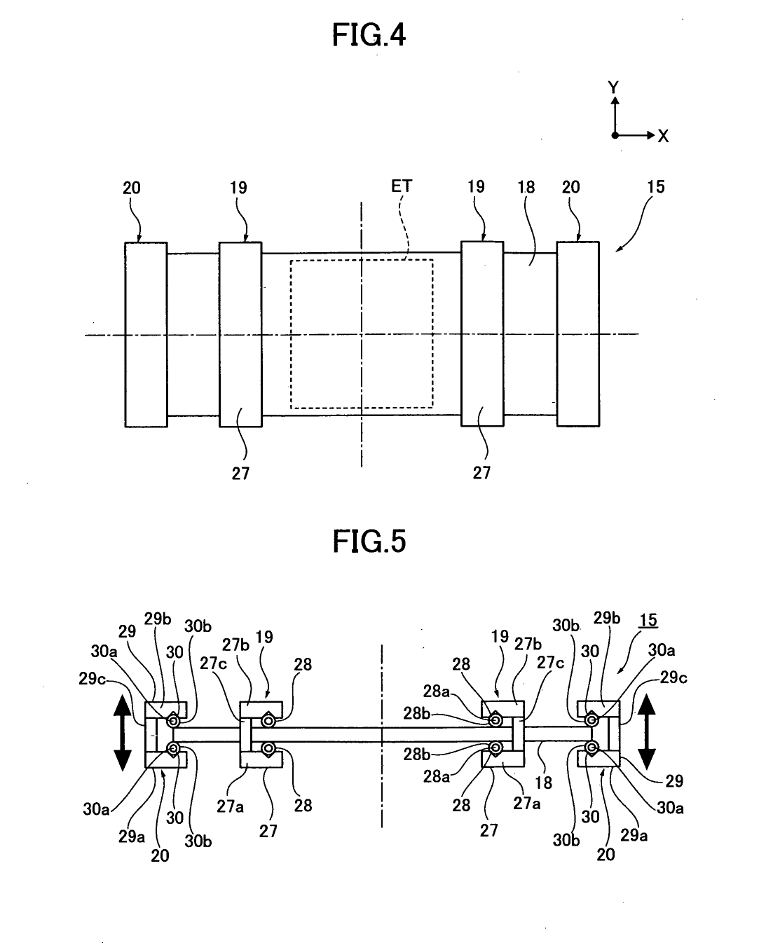

As shown in FIGS. 2 to 6, the left-to-right-direction magnification correcting mechanism 15 includes: a rectangular first plane-parallel plate (left-to-right-direction plane-parallel plate) 18 having long sides in the left-to-right direction and short sides in the front-to-back direction; paired restraint members 19; and paired pressure-nipping members (pressure members) 20. The front-to-back-direction magnification correcting mechanism 16 includes: a rectangular second plane-parallel plate (front-to-back-direction plane-parallel plate) 21 having long sides in the front-to-back direction and short sides in the left-to-right direction; paired restraint members 22; and paired pressure-nipping members (pressure members) 23.

The left-to-right-direction magnification correcting mechanism 15 and the front-to-back-direction magnification correcting mechanism 16 have the same configuration except that: the rectangular first plane-parallel plate 18 and the second plane-parallel plate 21 are arranged spaced out in the vertical direction, and orthogonal to each other, on the projection optical path of the mask pattern 13′; and corresponding to the orthogonal arrangement of the first plane-parallel plate 18 and the second plane-parallel plate 21, the arrangement positions of the paired restraint members 19 are different from those of the paired restraint members 22, and the arrangement positions of the paired pressure-nipping members 20 are different from those of the paired pressure-nipping members 23. For this reason, description will be given only of the left-to-right-direction magnification correcting mechanism 15.

Note that, in FIGS. 2 and 5, a square frame indicated by a chain-line represents a square crossing region where the first and second plane-parallel plates 18, 21 overlap each other, and also represents an effective projection optical path region ET of the light flux for exposure P. The light flux for exposure P is cast on the work substrate 14 through the effective projection optical path region ET.

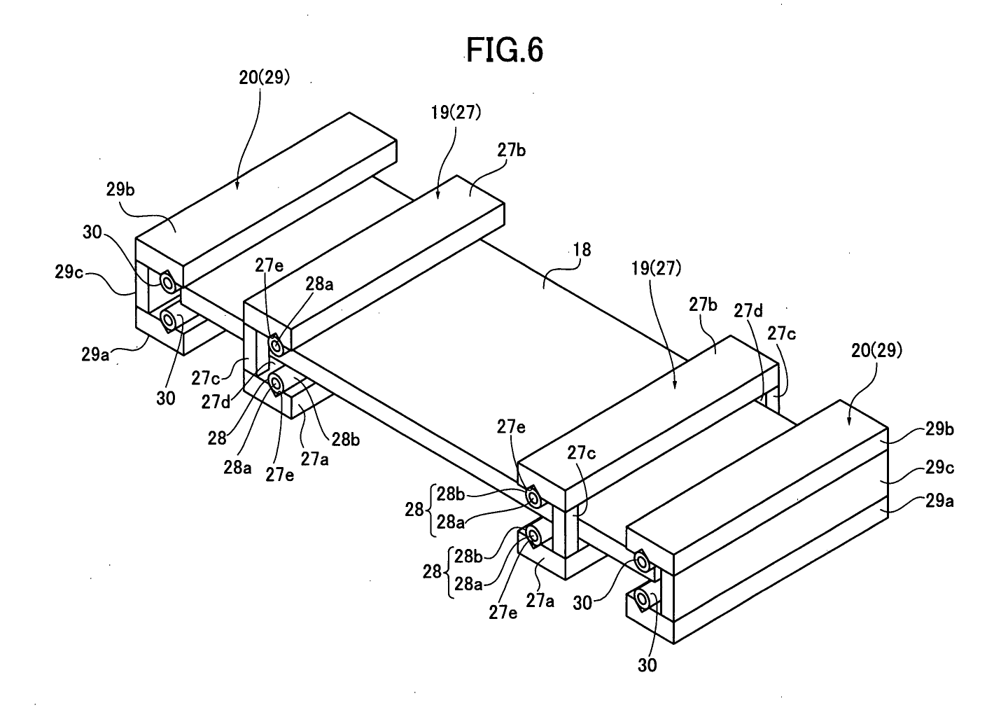

The paired restraint members 19 each include a supporting frame member 27 and cylindrical members 28. The supporting frame member 27 and the cylindrical member 28 each extend in a short-side direction of the first plane-parallel plate 18. The supporting frame member 27 includes a lower frame member 27a, an upper frame member 27b, and a connecting frame member 27c. As shown in FIG. 6, a guide opening 27d to guide the first plane-parallel plate 18 is formed between the lower frame member 27a and the upper frame member 27b.

Each cylindrical member 28 includes a columnar core member 28a made of iron or the like, and a covering resin 28b to cover the columnar core member 28a. The cylindrical members 28 are arranged in groove parts 27e of the lower frame members 27a and groove parts 27e of the upper frame members 27b. The cylindrical members 28 are in contact with the two surfaces of the first plane-parallel plate 18, respectively, and thereby restrain the first plane-parallel plate 18 in cooperation with the supporting frame member 27 in such a way that the first plane-parallel plate 18 can be deformed by warping.

As shown in FIGS. 5, 6, the paired pressure-nipping members 20 each include a nipping frame member 29 and cylindrical members 30 as in the case of the restraint members 19. The nipping frame member 29 and the cylindrical members 30 each extend in a short-side direction of the first plane-parallel plate 18. The nipping frame member 29 includes a lower frame member 29a, an upper frame member 29b, and a connecting frame member 29c. The connecting frame member 29c is connected to a drive arm (whose illustration is omitted).

Each cylindrical member 30 includes a columnar core member 30a made of iron or the like, and a covering resin 30b to cover the columnar core member 30a, as in the case of the cylindrical members 28. The cylindrical members 30 are arranged in the lower frame members 29a and the upper frame members 29b. The cylindrical members 30 are in contact with the two surfaces of the first plane-parallel plate 18, and thereby grasp the first plane-parallel plate 18 in cooperation with the nipping frame member 29.

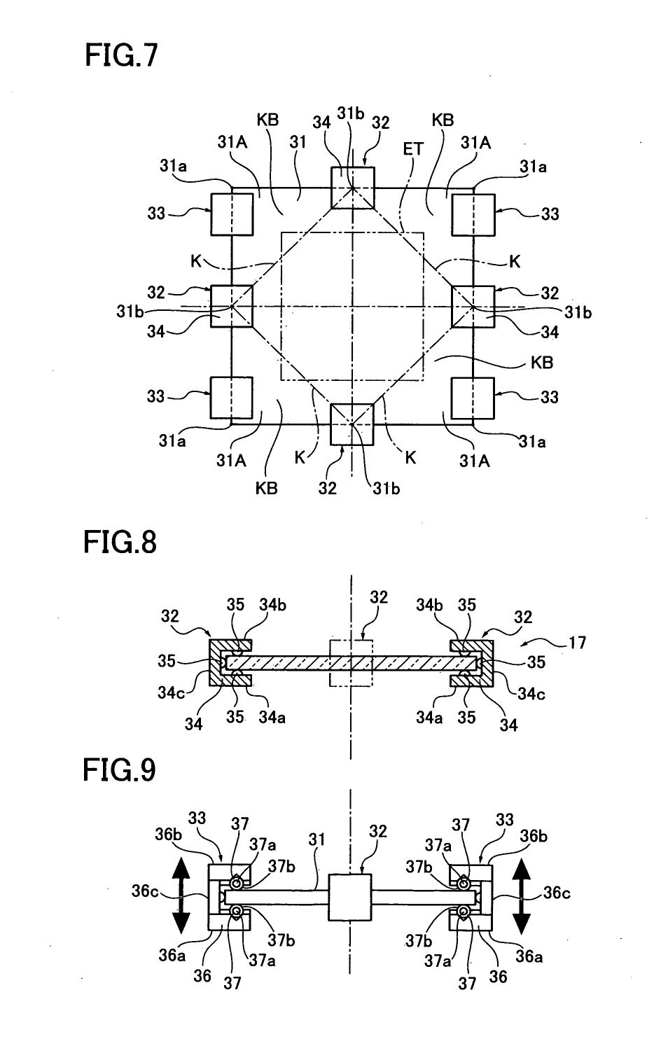

As shown in FIGS. 7 to 9, the warp deformation forming mechanism 17 includes a third plane-parallel plate (plane-parallel plate for warp deformation) 31, four finger-shaped restraint members 32, and four finger-shaped pressure-nipping members (pressure members) 33. The third plane-parallel plate 31 is formed from a square plate having sides which are longer than the short sides of the first and second plane-parallel plates 18, 21 and shorter than the long sides of the first and second plane-parallel plates 18, 21. The third plane-parallel plate 31 is arranged adjacent to the second plane-parallel plate 21.

Note that, in this embodiment, the first to third plane-parallel plates 18, 21, 31 are made of quartz glass.

As shown in FIG. 8, each restraint member 32 includes a supporting frame member 34 and resin-made hemispherical balls 35. The supporting frame member 34 includes a lower frame member 34a, an upper frame member 34b, and a connecting frame member 34c.

The restraint members 32 are respectively arranged at the midpoints of the sides of the third plane-parallel plate 31. In cooperation with the supporting frame member 34, the resin-made hemispherical balls 35 of each restraint member 32 restrains the midpoint of the corresponding side of the third plane-parallel plate 31 in three directions, i.e., from upper, lower, and left-to-right surfaces of the third plane parallel plate 31.

Each pressure-nipping member 33 includes a supporting frame member 36 and balls 37. The supporting frame member 36 includes a lower frame member 36a, an upper frame member 36b, and a connecting frame member 36c. The connecting frame member 36c is connected to a drive arm (whose illustration is omitted).

Each ball 37 includes a spherical iron core 37a and a covering resin 37b to cover the spherical iron core 37a. As shown in FIG. 7, the pressure-nipping members 33 are arranged at four corner parts 31A of the third plane-parallel plate 31, and nip triangle regions KB in such a way that the regions KB can be deformed by warping, respectively. In each triangle region KB, a line segment joining midpoints 31b of the corresponding two sides of the third plane-parallel plate 31 forms the base K, and a point 31a at which the corresponding two sides of the third plane-parallel plate 31 meet form the vertex.

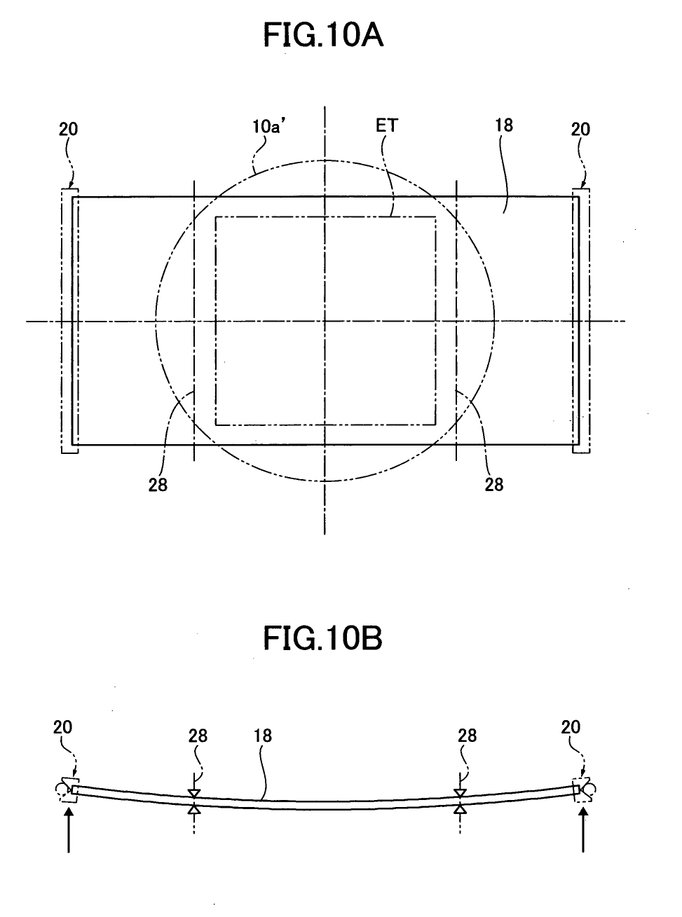

Next, an operation of the magnification correction in the left-to-right direction will be described while referring to a schematic diagram shown in FIG. 10.

The paired pressure-nipping members 20 are driven with the paired cylindrical members 28 used as their fulcrums, as schematically shown in FIG. 10A. Thus, the first plane-parallel plate 18 is curved in the optical axis direction of the projection optical path (in the thickness direction of the first plane-parallel plate 18), as shown in FIG. 10B. Thereby, the magnification in the left-to-right direction is corrected to decrease in accordance with the curvature of the first plane-parallel plate 18. Accordingly, a mask pattern image is scaled down corresponding to a rate of the contraction of the work substrate 14 in the left-to-right direction, and is projected to the work substrate 14. On the other hand, when the first plane-parallel plate 18 is curved in the opposite direction, the magnification in the left-to-right direction is corrected to increase. Accordingly, the mask pattern image is scaled up in accordance with a rate of the expansion of the work substrate 14 in the left-to-right direction, and is projected to the work substrate 14.

In this way, the magnification correction in the left-to-right direction of the work substrate 14 is carried out.

The magnification correction in the front-to-back direction is carried out in the same way as is the magnification correction in the left-to-right direction, except that the second plane-parallel plate 21 is curved. Thus, description thereof will be omitted.

Note that, in FIG. 10A, a circle 10a′ indicated by a chain double-dashed line represents the outer edge of the projection optical path of a mask pattern image.

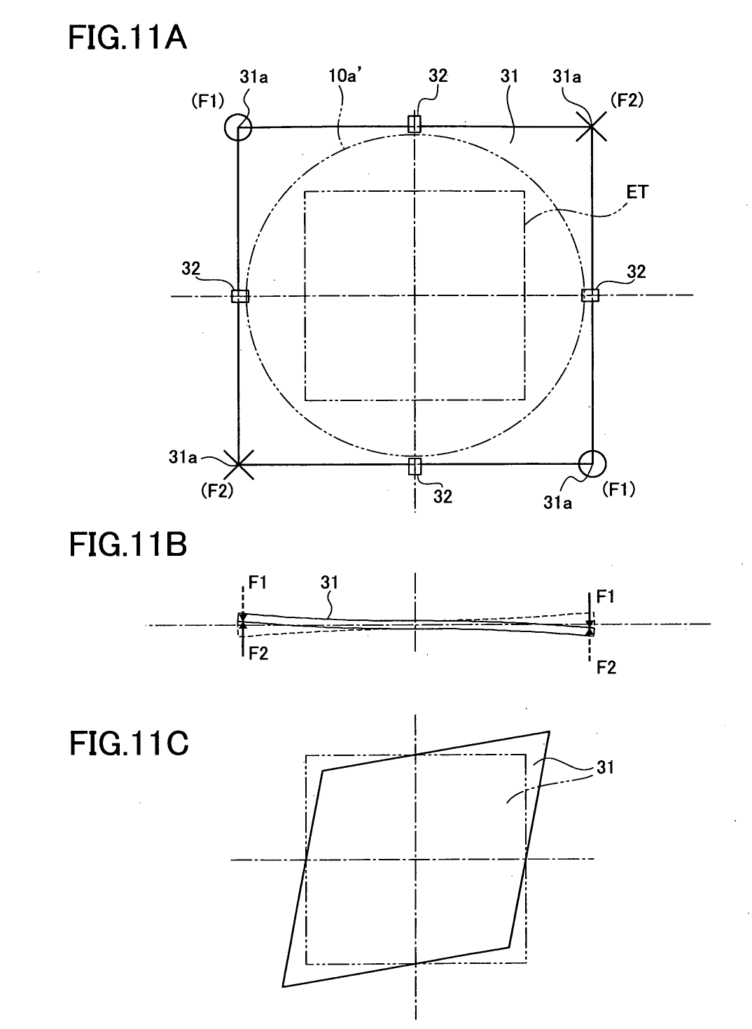

Next, an operation of the warp deformation forming mechanism 17 will be described by referring to schematic diagrams shown in FIGS. 11 to 13.

Among the vertices 31a at the four corners of the third plane-parallel plate 31 schematically shown in FIG. 11A, two vertices 31a joined by a given one of the diagonal lines are given a pressurizing force F1 acting toward the work substrate 14 and the other two vertices 31a joined by the other diagonal line orthogonal to the given diagonal line are given a pressurizing force F2 acting in a direction opposite to the direction of the pressurizing force F1 acting toward the work substrate 14, as shown in FIG. 11B. Under these pressurizing forces F1 and F2, the third plane-parallel plate 31 is deformed into a rhombus as shown in FIG. 11C. Thereby, in a case where the work substrate 14 deforms into a rhombus shape, the mask pattern deformed corresponding to the work substrate 14 deformed in the rhombus shape is projected onto the work substrate 14.

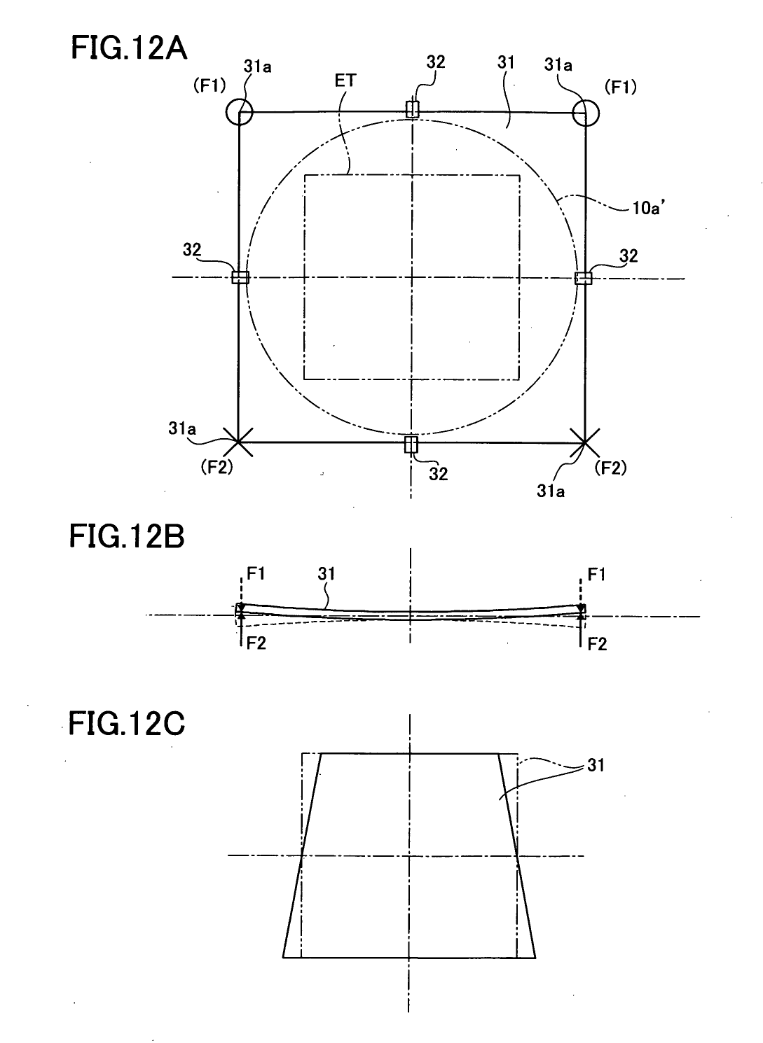

In another case, two vertices 31a joined by a given one of the left-to-right sides schematically shown in FIG. 12A are given a pressurizing force F1 acting toward the work substrate 14 and the other two vertices 31a joined by the other left-to-right side parallel to the given left-to-right side are given a pressurizing force F2 acting in a direction opposite to the direction of the pressurizing force F1 acting toward the work substrate 14, as shown in FIG. 12B. Under these pressurizing forces F1 and F2, the third plane-parallel plate 31 is deformed into a trapezoid shape having one of the left-to-right sides as the lower base and the other left-to-right side as the upper base as shown in FIG. 12C. Thereby, in a case where the work substrate 14 deforms into a trapezoid shape, the mask pattern deformed corresponding to the work substrate 14 deformed in the trapezoid shape is projected onto the work substrate 14.

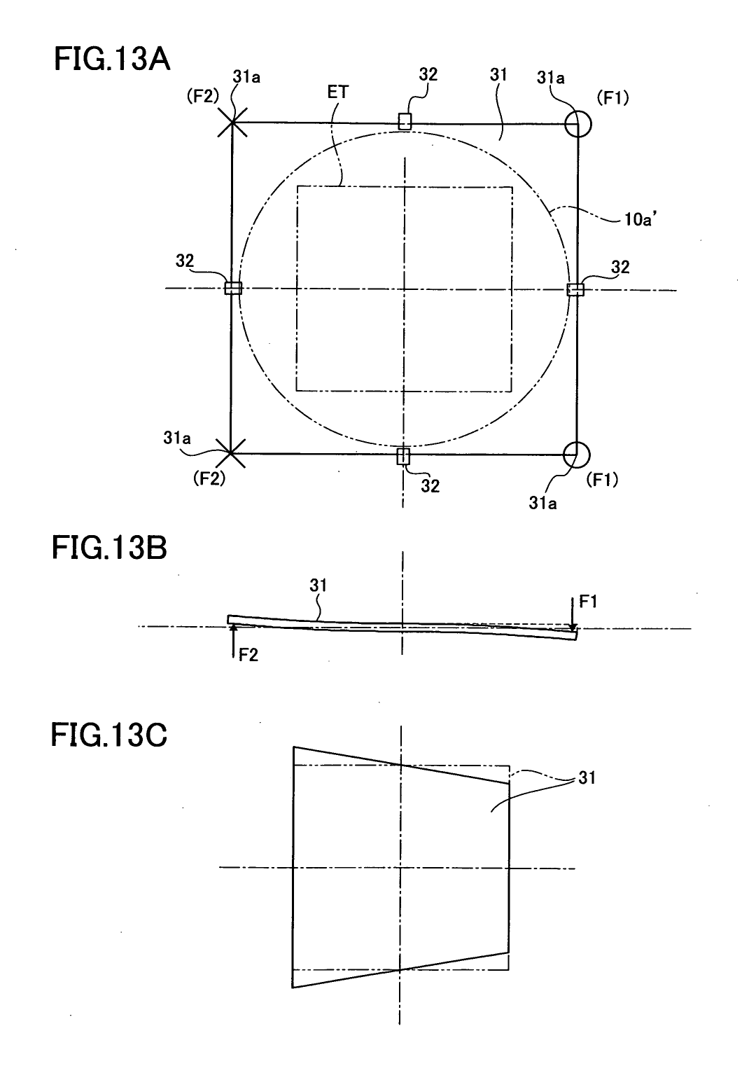

In still another case, two vertices 31a joined by a given one of the front-to-back sides schematically shown in FIG. 13A are given a pressurizing force F1 acting toward the work substrate 14 and the other two vertices 31a joined by the other front-to-back side parallel to the given front-to-back side are given a pressurizing force F2 acting in a direction opposite to the direction of the pressurizing force F1 acting toward the work substrate 14, as shown in FIG. 13B. Under these pressurizing forces F1 and F2, the shape of the third plane-parallel plate 31 is altered into a trapezoid shape having one of the front-to-back sides as the lower base and the other front-to-back side as the upper base as shown in FIG. 13C. Thereby, in a case where the work substrate 14 deforms into a trapezoid shape, the mask pattern with a shape altered corresponding to the work substrate 14 deformed in the trapezoid shape is projected onto the work substrate 14.

Further, it is possible to project a mask pattern image of a different rhombus shape or a different trapezoid shape to the work substrate 14 by adjusting the pressurizing forces to be applied by the pressure-nipping members 33.

In addition, although this embodiment has been described as the case where the third plane-parallel plate 31 is deformed by applying the pressurizing forces to the four corner parts 31A at one time, only one triangle region KB can be locally deformed into a different shape when only a corresponding one of the pressure-nipping members 33 situated in the respective four corner parts 31A applies a pressurizing force to the third plane-parallel plate 31.

Moreover, although this embodiment has been described as the case where the restraint members 32 are arranged at the midpoints 31b of the sides of the third plane-parallel plate 31, respectively, the present invention is not limited to this. When a holding member 32 is arranged in an intermediate part between every two corner parts 31A, a mask pattern image of a more complicated shape can be projected to the work substrate 14.

In addition, when multiple warp deformation forming mechanisms 17 are arranged on top of one another, it is also possible, for example, to form a mask pattern image of a shape obtained by combining a trapezoid shape and a rhombus shape; to form a mask pattern image of a combined shape of a trapezoid having the bases in the left-to-right direction and a trapezoid having the bases in the front-to-back direction; and to form a mask pattern image of a combined shape of a different trapezoid shape and a different rhombus shape by adjusting pressurizing forces.

Accordingly, when the left-to-right-direction magnification correcting mechanism 15, the front-to-back-direction magnification correcting mechanism 16, and the warp deformation forming mechanism 17 used in combination appropriately, it is possible to project a mask pattern image, which corresponds to the work substrate 14 deformed into a complicated shape, to the work substrate 14, and thereby to align the work substrate 14 with the mask pattern 13′ precisely.

As shown in FIG. 2, the exposure apparatus of this embodiment has such a structure that the corner parts 31A of the third plane-parallel plate 31 are exposed in corner spaces S each formed by one part of end parts 18a′ of long sides 18a of the first flat parallel plate 18 which protrude from the second plane-parallel plate 21, and by a corresponding and neighboring one of end parts 21a′ of long sides 21a of the second plane-parallel plate 21 which protrude from the first plane-parallel plate 18. This structure enables the left-to-right-direction magnification correcting mechanism 15, the front-to-back-direction magnification correcting mechanism 16, and the warp deformation forming mechanism 17 to be arranged close to one another, and thereby makes it possible to reduce the size of the entire correcting mechanism.

Further, in this embodiment, the first to third plane-parallel plates 18, 21, 31 are arranged between the work substrate 14 and the projection lens group 10a. Thereby, even when a gas or the like produced by a photosensitizing agent applied to the work substrate 14 is dispersed, such a gas or the like can be blocked from being dispersed toward the projection lens group. Thus, it is possible to prevent the fogging of the projection lens group 10a which would occur if the gas or the like is attached to the projection lens group 10a.

Note that, the first to third plane-parallel plates 18, 21, 31 are exchangeable as needed.

Further, the first to third plane-parallel plates 18, 21, 31 are supported by the restraint members 19, 22, 32 and the pressure-nipping members 20, 23, 33 with the hard and strong resins interposed in between. Thereby, the plane-parallel plates 18, 21, 31 can be prevented from being damaged or cracked as much as possible.

In this embodiment, the warp deformation forming mechanism 17 includes: the plane-parallel plate 31 for warp deformation which is provided on the projection optical path of the mask pattern 13′ to be projected onto the work substrate 14, and is configured to be deformed by warping; the restraint members 32, each of which causes an intermediate part between the corresponding two corner parts 31A to serve as a fulcrum, each corner part 31A being formed by the corresponding two intersecting sides of the plane-parallel plate 31 for warp deformation; and the pressure members 33 which are configured to cause the plane-parallel plate 31 for warp deformation with the restraint members 32 used as their fulcrums by applying the pressurizing force to the corner parts 31A of the plane-parallel plate 31 for warp deformation in the optical axis direction of the projection optical path. This makes it possible to project, to the work substrate 14, the mask pattern image with a shape corresponding to distortion/deformation which occurs in the work substrate 14, and which is beyond the correction capability of the left-to-right-direction magnification correcting mechanism 15 and the front-to-back-direction magnification correcting mechanism 16.

Further, more precise alignment can be achieved if the warp deformation forming mechanism 17 is used in combination with the left-to-right-direction magnification correcting mechanism 15 configured to correct the magnification of the mask pattern 13′ in the left-to-right direction and including: the first plane-parallel plate 18 provided on the projection optical path of the mask pattern 13′ to be projected to the work substrate 14; the paired restraint members 19 extending along the first plane parallel plate 18 in the front-to-back direction, and configured to restrain the first plane-parallel plate 18 so as to form therein the fulcrums extending in the front-to-back direction; and the paired pressure members 20 extending along the first plane-parallel plate 18 in the front-to-back direction, and configured to curve the first plane-parallel plate 18 in the optical axis direction of the projection optical path with the paired restraint members 19 used as their fulcrums by applying the pressurizing force to the paired front-to-back sides (short sides) of the first plane-parallel plate 18 in the optical axis direction of the projection optical path, and the front-to-back-direction magnification correcting mechanism 16 configured to correct the magnification of the mask pattern 13′ in the front-to-back direction and including: the second plane-parallel plate 21 provided on the projection optical path; the paired restraint members 22 extending along the second plane-parallel plate 21 in the left-to-right direction, and configured to restrain the second plane-parallel plate 21 so as to form therein fulcrums extending in the left-to-right direction; and the paired pressure members 23 extending along the second plane-parallel plate 21 in the left-to-right direction, and configured to curve the second plane-parallel plate 21 in the optical axis direction of the projection optical path with the paired restraint members 22 used as their fulcrums by applying the pressurizing force to the paired left-to-right sides (short sides) of the second plane-parallel plate 21 in the optical axis direction of the projection optical path.

As has been described in detail for this embodiment, the exposure apparatus includes the warp deformation forming mechanism 17 including: the plane-parallel plate 31 provided on the projection optical path of the mask pattern 13′ to be projected to the work substrate 14; the four restraint members 32 configured to restrain the midpoints of the sides of the plane-parallel plate 31, respectively, so as to cause the midpoints of the sides to serve as fulcrums, each midpoint being located between the corresponding two corner parts 31A each of which is formed by the corresponding two intersecting sides of the plane-parallel plate 31; and the four pressure members 33 configured to wrap and deform the plane-parallel plate 31 with the restraint members 32 used as their fulcrums by applying the pressurizing force to the corner parts 31A of the plane-parallel plate 31 in the optical axis direction of the projection optical path. Thus, it is possible to deform the plane-parallel plate 31 into a rhombus or a trapezoid by selecting the direction to apply the pressurizing force to each of the four corner parts 31A.

The exposure apparatus of this embodiment has the configuration including:

the left-to-right-direction magnification correcting mechanism 15 configured to correct the magnification of the mask pattern 13′ in the left-to-right direction, and including: the first plane-parallel plate 18 provided on the projection optical path of the mask pattern image to be projected to the work substrate 14; the paired restraint members 19 extending along the first plane-parallel plate 18 in the front-to-back direction, and configured to restrain the first plane-parallel plate 18 of so as to form therein the fulcrums extending in the front-to-back direction; and the paired pressure members 20 extending along the first plane-parallel plate 18 in the front-to-back direction and configured to curve the first plane-parallel plate 18 in the optical axis direction of the projection optical path with the paired restraint members 19 used as their fulcrums by applying the pressurizing force to the paired front-to-back sides of the first plane-parallel plate 18 in the optical axis direction of the projection optical path, the front-to-back-direction magnification correcting mechanism 16 configured to correct the magnification of the mask pattern 13′ in the front-to-back direction, and including: the second plane-parallel plate 21 provided on the projection optical path; the paired restraint members 22 extending along the second plane-parallel plate in the left-to-right direction 21, and configured to restrain the second plane-parallel plate 21 so as to form therein the fulcrums extending in the left-to-right direction; and the paired pressure members 23 extending along the second plane-parallel plate 21 in the left-to-right direction, and configured to curve the second plane-parallel plate 21 in the optical axis direction of the projection optical path with the paired restraint members 22 used as their fulcrums by applying the pressurizing force to the paired left-to-right sides of the second plane-parallel plate 21 in the optical axis direction of the projection optical path, and the warp deformation forming mechanism 17 including: the third plane-parallel plate 31 provided on the projection optical path; the four restraint members 32 configured to restrain the midpoints of the sides of the third plane-parallel plate 31, respectively, so as to cause the midpoints of the sides to serve as fulcrums, each midpoint being located between the corresponding two corner parts 31A, each of which is formed by the corresponding two intersecting sides of the third plane-parallel plate 31; and the four pressure members 33 configured to warp and deform the third plane-parallel plate 31 with the restraint members 32 used as their fulcrums by applying the pressurizing force to the corner parts 31A of the third plane-parallel plate 31 in the optical axis direction of the projection optical path.

As shown in FIG. 2, the left-to-right-direction magnification correcting mechanism 15, the front-to-back-direction magnification correcting mechanism 16, and the warp deformation forming mechanism 17 are arranged on top of one another on the projection optical path between the work substrate 14 and the projection lens group 10a, and the corner parts 31A of the third plane-parallel plate 31 are arranged to be exposed in the corner spaces S formed by the end parts 18a′ of the long sides 18a of the first plane-parallel plate 18 which protrude from the second plane-parallel plate 21, and the end parts 21a′ of the long sides 21a of the second plane-parallel plate 21 which protrude from the first plane-parallel plate 18. The configuration and arrangement make it possible to make exposure apparatus compact.

In the embodiment of the present invention, the plane-parallel plate for warp deformation, which is provided on the projection optical path of the work substrate, and the corner parts of the plane-parallel plate are deformed in the optical axis direction, which enables formation of a mask pattern image deformed by warping corresponding to distortion/deformation of a work substrate. This has an effect of making it possible to project, onto the work substrate, the mask pattern image having a shape corresponding to deformation which occurs in the work substrate, and which is beyond the correction capability of a left-to-right-direction magnification correcting mechanism and a front-to-back-direction magnification correcting mechanism.

Although the embodiment of the present invention has been described below, the present invention is not limited thereto. It should be appreciated that variations may be made in the embodiment described by persons skilled in the art without departing from the scope of the present invention.

What is claimed is:

1. An exposure apparatus comprising a warp deformation forming mechanism including:
a plane-parallel plate for warp deformation provided on a projection optical path of a mask pattern to be projected to a work substrate, and configured to be deformed by warping;
a restraint member configured to cause an intermediate part of the plane-parallel plate between neighboring two of corner parts to serve as a fulcrum, each corner part formed by two intersecting sides of the plane-parallel plate; and
a pressure member configured to warp and deform the plane-parallel plate with the restraint member used as a fulcrum by applying a pressurizing force to the corner parts of the plane-parallel plate in an optical axis direction of the projection optical path.

2. The exposure apparatus of claim 1, further comprising:
a left-to-right-direction magnification correcting mechanism configured to correct magnification of the mask pattern in a left-to-right direction and including
a left-to-right-direction plane-parallel plate provided on the projection optical path of the mask pattern to be projected to the work substrate,
paired restraint members extending along the left-to-right-direction plane-parallel plate in a front-to-back direction, and configured to restrain the left-to-right-direction plane-parallel plate to provide the left-to-right direction plane-parallel plate with fulcrums extending in the front-to-back direction, and
paired pressure members extending along the left-to-right-direction plane-parallel plate in the front-to-back direction, and configured to curve the left-to-right-direction plane-parallel plate in the optical axis direction of the projection optical path with the paired restraint members used as fulcrums by applying a pressurizing force to paired front-to-back sides of the left-to-right-direction plane-parallel plate in the optical axis direction of the projection optical path; and
a front-to-back-direction magnification correcting mechanism configured to correct magnification of the mask pattern in the front-to-back direction and including
a front-to-back-direction plane-parallel plate provided on the projection optical path,
paired restraint members extending along the front-to-back-direction plane-parallel plate in the left-to-right direction, and configured to restrain the front-to-back-direction plane-parallel plate to provide the front-to-back-direction plane-parallel plate with fulcrums extending in the left-to-right direction, and
paired pressure members extending along the front-to-back-direction plane-parallel plate in the left-to-right direction, and configured to curve the front-to-back-direction plane-parallel plate in the optical axis direction of the projection optical path with the paired restraint members used as fulcrums by applying a pressurizing force to paired left-to-right sides of the front-to-back-direction plane-parallel plate in the optical axis direction of the projection optical path.

3. An exposure apparatus comprising a warp deformation forming mechanism including:
a plane-parallel plate provided on a projection optical path of a mask pattern to be projected to a work substrate;
four restraint members configured to restrain midpoints of respective sides of the plane-parallel plate, so as to cause the midpoints of the sides to serve as fulcrums, each midpoint being located between neighboring two of corner parts each formed by two intersecting sides of the plane-parallel plate; and
four pressure members configured to warp and deform the plane-parallel plate with the restraint members used as fulcrums by applying a pressurizing force to the corner parts of the plane-parallel plate in an optical axis direction of the projection optical path.

4. An exposure apparatus comprising:
a left-to-right-direction magnification correcting mechanism configured to correct magnification of a mask pattern in a left-to-right direction, the mask pattern being to be projected to a work substrate, and including
a first plane-parallel plate provided on a projection optical path of the mask pattern,
paired restraint members extending along the first plane-parallel plate in a front-to-back direction, and configured to restraint the first plane-parallel plate to provide the first plane-parallel plate with fulcrums extending in the front-to-back direction, and
paired pressure members extending along the first plane-parallel plate in the front-to-back direction, and configured to curve the first plane-parallel plate in an optical axis direction of the projection optical path with the paired restraint members used as fulcrums by applying a pressurizing force to paired front-to-back sides of the first plane-parallel plate in the optical axis direction of the projection optical path;
a front-to-back-direction magnification correcting mechanism configured to correct magnification of the mask pattern in the front-to-back direction, and including
a second plane-parallel plate provided on the projection optical path,
paired restraint members extending along the second plane-parallel plate in the left-to-right direction, and configured to restrain the second plane-parallel plate to provide the second plane-parallel plate with fulcrums extending in the left-to-right direction, and
paired pressure members extending along the second plane-parallel plate in the left-to-right direction, and configured to curve the second plane-parallel plate in the optical axis direction of the projection optical path with the paired restraint members used as fulcrums by applying a pressurizing force to paired left-to-right sides of the second plane-parallel plate in the optical axis direction of the projection optical path; and
a warp deformation forming mechanism including
a third plane-parallel plate provided on the projection optical path,
four restraint members configured to restrain midpoints of respective sides of the plane-parallel plate, so as to cause the midpoints of the sides to serve as fulcrums, each midpoint being located between neighboring two of corner parts each formed by two intersecting sides of the plane-parallel plate, and
four pressure members configured to warp and deform the third plane-parallel plate with the restraint members used as fulcrums by applying a pressurizing force to the corner parts of the third plane-parallel plate in the optical axis direction of the projection optical path.

5. The exposure apparatus of claim 4, wherein the left-to-right-direction magnification correcting mechanism, the front-to-back-direction magnification correcting mechanism, and the warp deformation forming mechanism are arranged on top of one another on the projection optical path between the work substrate and a projection lens group.

6. The exposure apparatus of claim 5, wherein
the corner parts of the third plane-parallel plate are exposed in respective corner spaces each formed by one of end parts of long sides of the first plane-parallel plate protruding from the second plane-parallel plate, and by a neighboring one of end parts of long sides of the second plane-parallel plate, the end parts of the first plane-parallel plate protruding from the first plane-parallel plate.

7. The exposure apparatus of any one of claim 3, wherein each of the plane-parallel plates is deformable into a rhombus shape or a trapezoid shape by selecting a direction to apply a pressurizing force to each of the four corner parts.
